(19) United States
(12) Patent Application Publication
(10) Pub. No.: US 2014/0173528 A1
(43) Pub. Date: Jun. 19, 2014

(54) CONTACT ENVIRONMENTS WITH DYNAMICALLY CREATED OPTION GROUPS AND ASSOCIATED COMMAND OPTIONS

(71) Applicant: MICROSOFT CORPORATION, Redmond, WA (US)

(72) Inventors: Christina M. Meyer, Seattle, WA (US); Dengkui Xi, Redmond, WA (US); Xiaoyu Li, Issaquah, WA (US); Joshua Hinds, Duvall, WA (US)

(73) Assignee: Microsoft Corporation, Redmond, WA (US)

(21) Appl. No.: 13/714,129

(22) Filed: Dec. 13, 2012

(51) Int. Cl. G06F 3/0484

(52) U.S. Cl. CPC G06F 3/0484
USPC 715/863

(57) ABSTRACT

Disclosed herein are systems, methods, and software for facilitating contact environments. In one implementation, a computing system presents a view of a contact environment comprising a canvas and a plurality of contacts arranged on the canvas. Responsive to a plurality of inclusion gestures, each gestures indicative of an intention to include a different one of the plurality of contacts in an option group, the computing system identifies which of the plurality of contacts to include in the option group. The computing system presents a modified view of the contact environment comprising a plurality of included contacts identified in response to the plurality of inclusion gestures.

### TECHNICAL FIELD

Aspects of the disclosure are related to computing and communication technology, and in particular, to inclusion gestures in contact environments.

### TECHNICAL BACKGROUND

Many software applications provide contact-related tools and environments through which users may search for people in their contacts and implement commands, such as initiating communication sessions, managing their contacts, and the like. For example, a user may navigate to a particular contact associated with a person. A view of the contact may include various command options corresponding to the various ways in which a user may interact with the contact, such as organizational or communication options.

For example, it is possible in many contact environments to select a particular contact and modify details about the contact, assign the contact to a group, or perform other detailed or organizational functions. A variety of ways exist for creating contact groups. In many contact environments a group may be created by naming a group and then individually selecting contacts to place in the group. In other environments groups may be dynamically created from a communication, such as an email or invite that already includes or otherwise identifies a collection of contacts, and designating that collection of contacts as a group.

Once a group is created it is possible to interact with a group of contacts in a variety of ways to perform various functions. In one example a user may select an object representative of a pre-defined group and from there initiate a communication via one of several options presented to the user, such as an email or invite option. In another example a user may begin a group communication by launching a corresponding communication application and then selecting the group to involve in the group communication.

### OVERVIEW

Provided herein are systems, methods, and software for facilitating contact environments. In an implementation, a contact environment includes contacts. Users may indicate via inclusion gestures their intention to include at least some of the contacts in an option group. A view of the contact environment may then be presented with the contacts and the option group, which includes the selected contacts sometimes referred to as included contacts. The contact environment may also various command options available for interacting with the included contacts in the option group. Responsive to an option gesture corresponding to a specific option represented in the command options, a command operation may be initiated in accordance with the specific option.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a view of a contact environment in an implementation.

FIG. 2 illustrates a contact process in an implementation.

FIG. 3 illustrates a computing system in an implementation.

FIGS. 4-7 illustrate various views of a contact environment in various implementations.

FIG. 8 illustrates another computing system in an implementation.

### TECHNICAL DISCLOSURE

Implementations described herein provide for enhanced contact environments that allow for the dynamic grouping of multiple contacts into option groups such that command operations may be performed with respect to the option groups. Such enhancements are facilitated by way a graphical representation of an option group that may be populated with multiple contacts using intuitive inclusion gestures. Users may communicate their intention to group multiple contacts together by performing an inclusion gestures for each contact.

The resulting group of included contacts can then be represented within the option group, in addition to graphical representations of command options applicable to the included contacts. Interaction with the command options, such as a touch or other indicative gestures, leads to the initiation of a command operation with respect to the included contacts. For example, an organizational operation such as assigning the included contacts to a group may be performed. In another example, a communication session may be initiated that involves the included contacts.

In some implementations, responsive to inclusion gestures, each of the of inclusion gestures indicative of an intention to include a different one of several contacts in an option group, a view is presented of a contact environment. The contact environment includes the several contacts, multiple included contacts in the option group, and command options applicable to the included contacts in the option group. Responsive to an option gesture corresponding to a specific option represented in by the command options, a command operation involving the included contacts is initiated in accordance with the specific option.

In some implementations the contact environment includes a canvas with the several contacts arranged separately from the multiple included contacts on the canvas. In some implementations, the contact environment includes the canvas, an application bar arranged adjacent to the canvas, and a contact basket arranged within the application bar which has the included contacts represented therein. In some scenarios, the contacts are individual contacts and the inclusion gestures are slide gestures directed from the individual contacts over the canvas towards the option group.

In various implementations the option group may be visually expanded or contracted in response to various gestures. For example, responsive to an exclusion gesture indicative of an intention to exclude a contact from the option group, a modified view of the contact environment may be presented with included contacts in the option group, less the contact subject to the exclusion gesture. In addition, the option group may be visually contracted in response to the exclusion gestures. In response to some inclusion gestures that add contacts to the option group, the option group may visually expand when the inclusion gestures occur.

In addition, to contacts, other types of objects may be included in the option group in some implementations. The other types of objects may then be included in any resulting command operation. For example, a document may be included in the option group by way of an object inclusion gesture. The document may then be distributed automatically to participants associated with the contacts in a subsequent communication session.

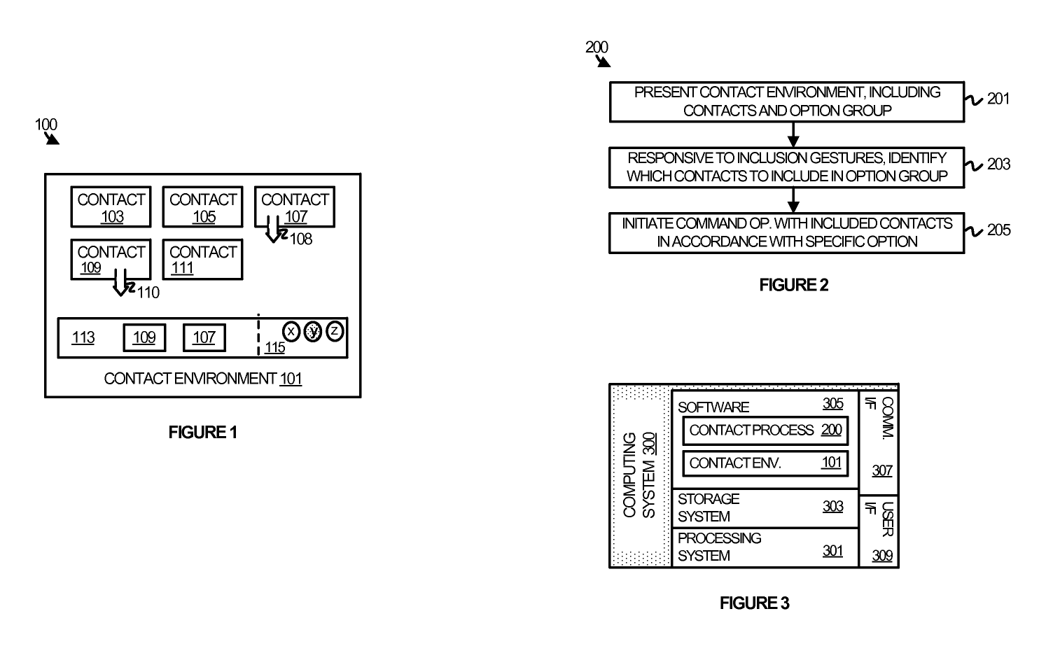

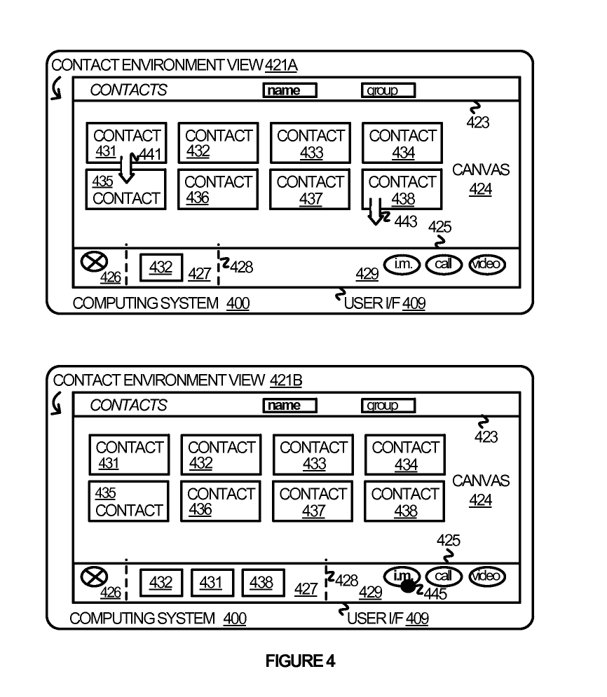

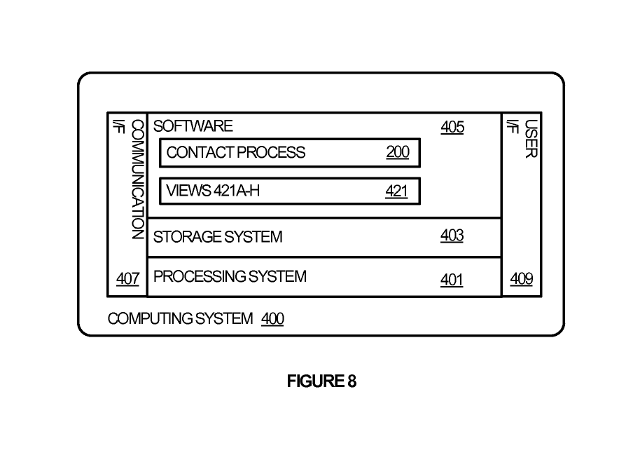

Referring now to the drawings, FIG. 1 illustrates a contact environment, while FIG. 2 illustrates a contact process applicable to the contact environment. FIG. 3 illustrates a computing system suitable for implementing the contact environment and process. FIGS. 4-7 illustrate various views of another contact environment implemented on another representative computing system, while FIG. 8 illustrates the computing system in more detail.

The following discussion of FIGS. 1-8 for purposes of clarity may refer to various elements included in various contact environments, such as contacts, included contacts, option groups, command options, application bars, and baskets without reference to those elements as graphical objects or graphical representations of the same. However, it may be appreciated that such terms and phrases may be used interchangeably and such usage does not limit the scope of the present disclosure. To the contrary, the present disclosure may be considered to encompass a wide variety of techniques for representing the various elements included in the various contact environments discussed throughout. Thus, these and other elements illustrated in FIGS. 1-8 may embodied in graphical objects, other data structures, other graphical representations of the elements, or other combinations or variations thereof. For example, a contact referred to as such with respect to the Figures be considered a contact, a contact object, a graphical representation of a contact, and so on.

Turning to FIG. 1, a view 100 of contact environment 101 is illustrated in an implementation. The view 100 of contact environment 101 may be rendered by any suitable computing device capable of executing a contact application or portions thereof or interacting with some other computing system capable of executing a contact application or portions thereof. For example, the view 100 of contact environment 101 may be rendered on the display of a tablet, laptop, or desktop computer, a smart phone, mobile device, gaming system, or some other type of computing system. The contact application may be locally installed, hosted remotely and accessed through a browser, or streamed from a remote source for local execution, or implemented using some other technique, combination of techniques, or variation thereof. Computing system 300 illustrated in FIG. 3 is one example of a suitable computing system, a discussion of which is provided below.

Contact environment 101 includes contacts 103, 105, 107, 109, and 111. Contacts 103, 105, 107, 109, and 111 may each be any contact graphic, icon, object or other suitable element representative of contact information with which a user may interact by way of inclusion gestures. Each contact may generally correspond to a person and may include a collection of information corresponding to the person, at least a portion of which may be used to communicate with the person. For example, contact 107 and contact 109 may include a variety of contact information, such as a person's name, phone number, email address, service handle, a physical address, or any other suitable contact information.

Contact environment 101 also includes option group 113 and command options 115. Option group 113 may be any graphic, object, or other suitable element representative of a group in which some contacts may be included by way of inclusion gestures. Command options 115, represented herein by options X, Y, and Z, are representative of any graphic, object, or other suitable element representative of command options in accordance with which command operations may be initiated. As an example, option X, Y, and Z may correspond to phone, chat, and video conference command options.

FIG. 2 illustrates contact process 200 in an implementation. The following discussion of contact process 200 will proceed with respect to contact environment 101, although it may be appreciated that contact process 200 could be employed with respect to other contact environments and contexts.

In operation, contact environment 101 is presented, including at least a rendering of several contacts and option group 113 (step 201). Contact environment 101 may be presented for a variety of reasons or within a variety of scenarios. As an example, contact environment 101 may be presented within the context of launching a contacts application. In another example, a user may navigate to contact environment 101 from within another application. In any case, once presented, contact environment 101 allows a user to interact with contacts to assemble options groups and initiate a variety of types of communications once the groups are assembled.

In particular, a user may interact with contact environment 101 by way of inclusion gestures. FIG. 1 illustrates two such inclusion gestures 108 and 110 for exemplary purposes. In FIG. 1, inclusion gestures 108 and 110 are both represented as downward slides or swipes beginning nearby contacts 107 and 109 and proceeding towards option group 113. Such inclusion gestures are indicative of an intention to include a contact in an option group, such that group communications or other features may be commenced with respect to that contact and others in the option group. While inclusion gestures 108 and 110 are illustrated and downward swipes or slides, it may be appreciated that other types of gestures are possible and may be considered within the scope of this disclosure.

Responsive to inclusion gestures 108 and 110, which contacts are to be included in option group 113 are identified (step 203). This may generally be accomplished by analyzing information corresponding to inclusion gestures 108 and 110, such as the location, duration, and direction of a touch or other input used to create inclusion gestures 108 and 110. Such analysis is well known in the art within the context of user interfaces and thus the present disclosure refrains from a lengthy discussion. In this example, contacts 107 and 109 are identified as included in option group 113. Accordingly, option group 113 is presented with contacts 107 and 109 presented therein.

Note that, as a result of including contacts 107 and 109 in option group 113, two copies or versions of contacts 107 and 109 may be presented simultaneously. The visual features of contacts 107 and 109 as presented within option group 113 may be different relative to the visual features of contacts 107 and 109 as presented along with the other contacts in contact environment 101. For example, contacts 107 and 109 may be smaller or contain less visual information when presented within option group 113. It is also possible for the visual features of contacts 107 and 109 as presented separate from option group 113 to change upon their selection for inclusion in option group 113. For example, a shading effect or some other technique may be implemented to visually indicate that contacts 107 and 109 have been selected for inclusion in option group 113. When presented within option group 113, contacts 107 and 109 may be referred to as included contacts due to their inclusion in option group 113.

Command options 115 are also presented along with the representation of contacts 107 and 109 in option group 113. Any one of command options 115 may be selected by way of an option gesture, such as a touch, or any other type of user input suitable for selecting one of the options. Responsive to the option gesture corresponding to a specific option of command options 115, a command operation is initiated with the included contacts in option group 113 (step 205). For example, a group chat session may be initiated between the user interacting with contact environment 101 and other participants associated with contacts 107 and 109. In another example, a video conference may be initiated between the user interacting with contact environment 101 and other participants associated with contacts 107 and 109. In yet another example, an online meeting may be initiated between the user and other participants associated with contacts 107 and 109.

Variations of contact process 200 are possible, such as initiating each of the aforementioned steps, in addition to or in place of actually performing each of the aforementioned steps. For example, contact process 200 may include initiating the presentation of a contact environment, initiating the identification of contacts, and initiating the presentation of a modified view. In another example, others steps in addition to or in place of those described by contact process 200 may be implemented. In one implementation, contact process 200 may include receiving the inclusion gestures, each indicative of the intention to include a different one of the contacts in option group 113. In another implementation, contact process 200 may include presenting a modified view of contact environment 101, including a view of the included contacts in option group 113.

Computing system 300, illustrated in FIG. 3, may be representative of any computing apparatus, system, or systems on which contact process 200 or variations thereof may be suitably implemented. Optionally, computing system 300 may also be suitable for implementing all of or portions of contact environment 101. Implementing contact process 200 or variations thereof may include local execution, streaming execution, or hosted execution of contact process 200, or any combination or variation thereof. Examples of computing system 300 include mobile computing devices, desktop computers, cell phones, tablet computers, laptop computers, notebook computers, media devices, and gaming devices, as well as any other type of mobile computing devices and any combination or variation thereof. Examples of computing system 300 may also include server computers, cloud computing platforms, and virtual machines, as well as any other type of computing system, variation, or combination thereof.

Computing system 300 includes processing system 301, storage system 303, software 305, communication interface 307, and user interface 309. Processing system 301 is operatively coupled with storage system 303, communication interface 307, and user interface 309. Processing system 301 loads and executes software 305 from storage system 303. When executed by computing system 300 in general, and processing system 301 in particular, software 305 directs computing system 300 to operate as described herein for contact process 200 or variations thereof. Computing system 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variations thereof.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal. In addition to storage media, in some implementations storage system 303 may also include communication media over which software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 301.

Software 305 may be implemented in program instructions and among other functions may, when executed by computing system 300 in general or processing system 301 in particular, direct computing system 300 or processing system 301 to operate as described herein for contact process 200. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform computing system 300 overall from a general-purpose computing system into a special-purpose computing system customized to facilitate contact environments as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 300 is generally intended to represent a computing system with which software 305 is deployed and executed in order to implement contact process 200 (and variations thereof) and optionally all or portions of contact environment 101. However, computing system 300 may also represent any computing system on which software 305 may be staged and from where software 305 may be distributed, transported, downloaded, or otherwise provided to yet another computing system for deployment and execution, or yet additional distribution.

Referring again to FIG. 1, through the operation of computing system 300 employing software 305, transformations may be performed with respect to contact environment 101. As an example, contact environment 101 could be considered transformed from one state to another when subject to contact process 200 or variations thereof. In a first state, computing system 300 may render the view 100 of contact environment 101 without some or all of contacts 107 and 109 included in option group 113. Responsive to inclusion gestures indicative of intentions to include contacts 107 and 109 in option group 113, contact environment 101 may be modified, and thus the view 100 of contact environment 101 modified to render option group 113 with the included contacts represented therein, thereby changing contact environment 101 to a second, different state. In another example, responsive to an options gesture made with respect to command options 115, a command operation may be initiated, thereby changing contact environment 101 to another, different state.

Referring again to FIG. 3, communication interface 307 may include communication connections and devices that allow for communication between computing system 300 and other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface 309 may include a mouse, a voice input device, a touch input device for receiving a touch gesture from a user, a motion input device for detecting non-touch gestures and other motions by a user, and other comparable input devices and associated processing elements capable of receiving user input, such as inclusion gestures and option gestures, from a user. Output devices such as a display, speakers, haptic devices, and other types of output devices may also be included in user interface 309. In some cases, the input and output devices may be combined in a single device, such as a display or surface capable of displaying images, such as views of contact environment 101, and receiving touch gestures. The aforementioned user input and output devices are well known in the art and need not be discussed at length here. User interface 309 may also include associated user interface software executable by processing system 301 in support of the various user input and output devices discussed above. Separately or in conjunction with each other and other hardware and software elements, the user interface software and devices may provide a graphical user interface, a natural user interface, or any other kind of user interface.

FIGS. 4-7 illustrate various views 421A-H of a contact environment that may be rendered by computing system 400 when executing a contact application or portions thereof, or interacting with some other computing system capable of executing a contact application or portions thereof. The contact application may embody a contact process such as contact process 200 or variations thereof that result in the variation between views 421A-H during various stages of execution. The contact application may be locally installed, hosted remotely and accessed through a browser, or streamed from a remote source for local execution, or implemented using some other technique, combination of techniques, or variation thereof. The contact application may be a stand-alone application, integrated with an operating system, or may be incorporated within a larger application, such as a unified communications application. One such application is Lync® from Microsoft®. Computing system 400 renders the views 421A-H of the contact environment on user interface 409.

In view 421A, the contact environment includes a title bar 423 that describes the view and a viewing mode. In this example, the viewing mode may be one of a name mode or a group mode, which are provided for illustrative purposes only and may vary. In the name mode, contacts may be viewed by name, while pivoting to the group mode allows contacts to be viewed in groups. When adding contacts to contact basket 427, as is discussed in more detail below, it is possible to add contacts from within the name mode, the group mode, or both. In fact, it may be possible to pivot between the two such that contacts can be added from each view mode.

The contact environment also includes a canvas 424 on which contacts 431-438 are arranged and displayed. Application bar 425 includes a clear function 426, a contact basket 427, and a separation bar 428 that separates contact basket 427 from communication commands 429. Communication options 429 includes several options for communicating with participants associated with contacts that may be included in contact basket 427, including instant message, voice call, and video conferencing options.

View 421A further illustrates some operational aspects of the content environment. In operation, the contact environment is presented for interaction with a user. The contact environment may be presented for a variety of reasons or within a variety of scenarios, such as the launching of a dedicated contacts applications, the navigation to the contact environment from within some other application, or for any other reason. Once presented, a user may interact with at least some of contacts 431-438 to assemble them in contact basket 427. A variety of types of communications may then be initiated once the group is assembled.

It is assumed for exemplary purposes in view 421A that contact 432 had previously been selected by an inclusion gesture to be included in contact basket 427. View 421A illustrates two additional inclusion gestures 441 and 443 corresponding to contacts 431 and 438 respectively. Inclusion gestures 441 and 443 are both represented as downward swipes beginning nearby contacts 431 and 438 respectively and proceeding towards contact basket 427. Note that the inclusion gestures may occur in a serial manner, although it may be possible to perform both gestures in a substantially simultaneous manner. Inclusion gestures 441 and 443 are indicative of an intention to include contacts 431 and 438 in contact basket 427. While inclusion gestures 441 and 443 are illustrated and downward swipes or slides, it may be appreciated that other types of gestures are possible and may be considered within the scope of this disclosure.

Referring now to view 421B, responsive to inclusion gestures 441 and 443, contacts 431 and 438 are rendered in contact basket 427. Considered in sequence, it may be appreciated that view 421B differs relative to view 421A by the inclusion of contacts 431 and 438 in contact basket 427. In addition, contact basket 427 has been visually expanded by moving separation bar 428 to the right in order to accommodate the addition of contacts 431 and 438 in contact basket 427.

View 421B also illustrates an option gesture 445 representative of a selection of one of the communication commands 429. For exemplary purposes it is assumed that the instant messaging function or command is selected, in response to which an instant message or chat sessions may be initiated with the included contacts in contact basket 427, contact 432, contact 431, and contact 438. Other commands may also be possible, such as a command to define a new group consisting of the contacts in contact basket 427 or a command to add the contacts in contact basket 427 to an existing group.

As mentioned above, it may be possible to select contacts in both viewing modes—when contacts are arranged by name and when contacts are arranged by groups. In fact, in some scenarios a contact may initially be selected when viewed in the name mode. Upon pivoting to the group mode, the same contact may have its appearance altered such that the user is alerted to the fact that the contact has already been selected for inclusion in contact basket 427. A similar change in the appearance of any contact is possible upon the contact being included in contact basket 427. For example, a shading effect may be implemented with a particular contact upon its inclusion in contact basket 427 to alert the user to the fact.

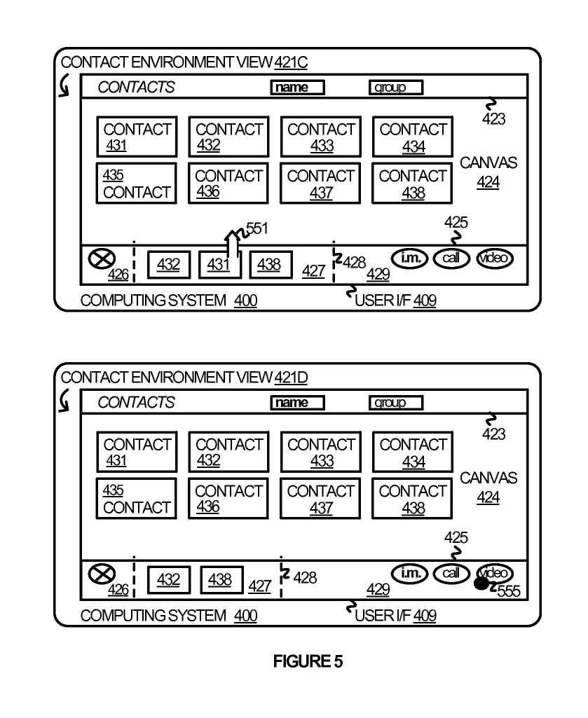

Referring to FIG. 5, view 421C illustrates a scenario whereby a contact may be removed from contact basket 427. In particular, view 421C includes exclusion gesture 551 pertaining to contact 431 in contact basket 427. Exclusion gesture 551 is a slide or swipe beginning nearby contact 431 in contact basket 427 and proceeding in a direction towards contacts 431-438 on canvas 424. In view 421D, contact 431 has been eliminated from contact basket 427. In addition, contact basket 427 has been visually contracted and separation bar 428 moved to the left to reflect the reduced size of contact basket 427.

View 421C also illustrates an option gesture 555 representative of a selection of one of the communication commands 429. For exemplary purposes it is assumed that the video conference function or command is selected, in response to which a video conference may be initiated with the included contacts in contact basket 427, contact 432 and contact 438, but not contact 431 due to its exclusion. Other commands may also be possible, such as a command to define a new group consisting of the contacts in contact basket 427 or a command to add the contacts in contact basket 427 to an existing group.

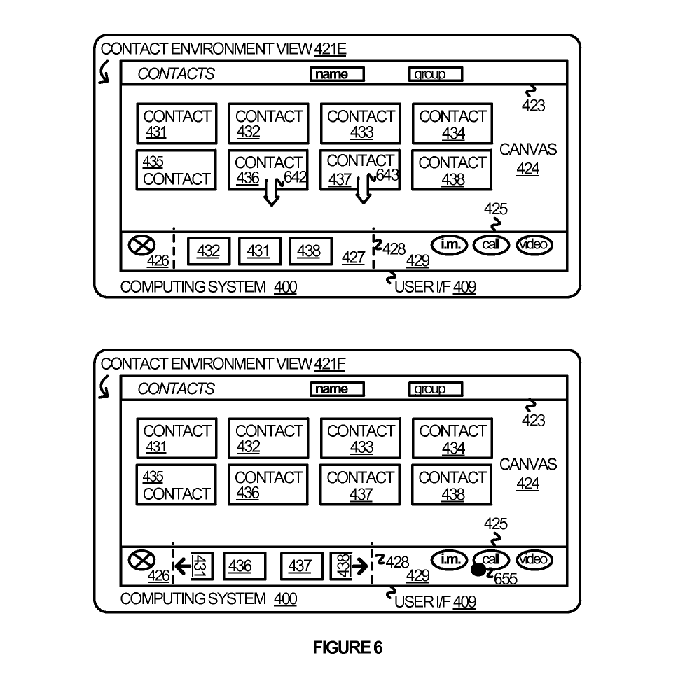

Referring to FIG. 6, view 421E and view 421F illustrate a scenario whereby a sufficient quantity of contacts are added to contact basket 427 to cause it to become scrollable. In particular, inclusion gestures 642 and 643 are received with respect to contacts 436 and 437. It is assumed for exemplary purposes that contact basket 427 already includes contacts 432, 431, and 438 as a result of previously received inclusion gestures. Thus, contact basket 427 has already expanded visually to accommodate those contacts.

Instead, as illustrated in view 421F contact basket 427 becomes visually scrollable to either side. All five contacts are included in contact basket 427, but only some of them are visible at any given time. For example, contact 436 and contact 437 can be viewed in their entirety, but only portions of contact 431 and contact 438 can be viewed. Contact 432 is hidden entirely. However, scrolling to the left would uncover contact 432, while scrolling to the right would bring contact 438 into full view. In the event that one or more contacts are removed from contact basket 427, then the visibility of each contact may revert back to a state where each contact can be seen in its entirety.

View 421F also illustrates an option gesture 655 representative of a selection of one of the communication commands 429. For exemplary purposes it is assumed that the voice call function or command is selected, in response to which a conference call may be initiated with the included contacts in contact basket 427, contacts 432, 431, 436, 437, and 438. Other commands may also be possible, such as a command to define a new group consisting of the contacts in contact basket 427 or a command to add the contacts in contact basket 427 to an existing group.

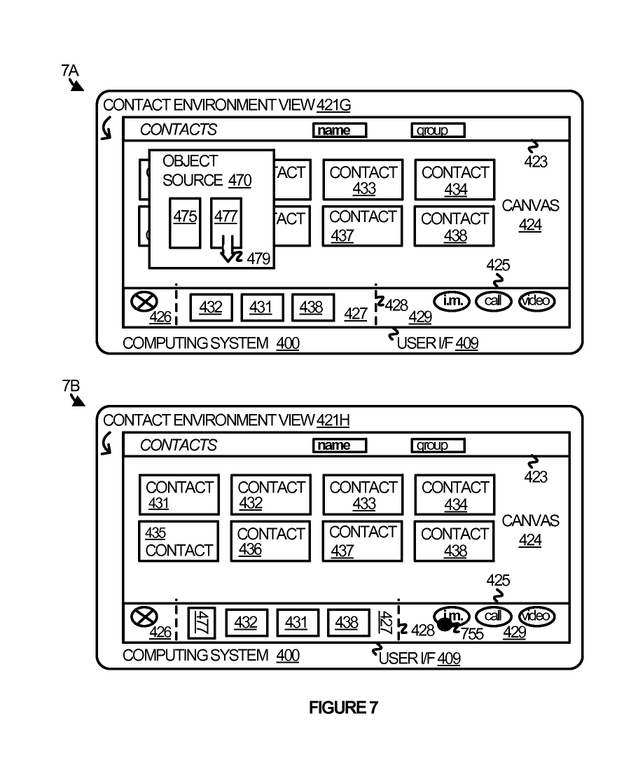

Referring to FIG. 7, view 421G and view 421H illustrate a scenario whereby an object, such as a file, is added to contact basket 427. View 421G includes object source 470, which itself includes objects 475 and 477. Object source 470 may be any source that contains objects that may be included in contact basket 427. Examples of object source 470 include folders and other data structures capable of storing a file or representing as file as stored therein. Object source 470 may be a local object source but may also be a remote object source. Object source 470 is illustrated as displayed over canvas 424 and covering some of contacts 431-438. However, it may be appreciated that object source 470 could be displayed in other ways. For example, a user may navigate away from the view of the contact environment to a different view that includes object source 470. However, in such a scenario it may be possible for application bar 425, or at least contact basket 427, to persist such that inclusion gestures in the new view may be made with reference to it.

In operation, a user may make inclusion gesture 479, such as by providing a downward slide across canvas 424 towards contact basket 427. Such a gesture, having originated on or nearby object 477, provides an indication of an intention to include object 477 in contact basket 427. As a result, object 477 is rendered within contact basket 427, as illustrated by view 421H. View 421H also illustrates an option gesture 755 representative of a selection of one of the communication commands 429. For exemplary purposes it is assumed that the instant message or chat feature is selected, in response to which a group chat may be initiated with the included contacts in contact basket 427, contacts 432, 431, and 438, and object 477. For example, an invitation to the group chat may be distributed to contacts 432, 431, and 438 with object 477 attached thereto. In another example, object 477 may be automatically deposited into or uploaded to a group chat room from which it may be downloaded or otherwise retrieved by the participants.

While FIGS. 4-7 illustrate various features and functions exhibited through views 421A-H, other features and functions may be possible. For example, a long press on contacts represented in contact basket 427 may yield a display of contact information associated with the contact, such as a person's name.

In addition, it may be possible to add entire groups to contact basket 427. For example, a pre-defined group may be represented by a group icon or object, similar to a contact. An inclusion gesture may be performed with respect to the group icon such that the group is dropped into or otherwise included in contact basket 427, possibly along with other individual contacts. The group could remain represented as a group in contact basket 427. However, in some scenarios it may be that the group is separated out into its individual contacts such that multiple contacts from the group are displayed within contact basket 427.

In another example, application bar 425 or at least contact basket 427 may persist even upon navigating to other views. One such example is provided above with respect to object source 470. However, it may be possible to navigate to other views or variations of views 421A-H while persisting application bar 425 or at least contact basket 427 so that other contacts or objects available through those views can be included.

FIG. 8 illustrates computing system 400 in more detail. Computing system 400 may be representative of any computing apparatus, system, or systems on which contact process 200 or variations thereof may be suitably implemented and views 421A-H suitably implemented. Optionally, computing system 400 may also be suitable for implementing all of or portions of the contact environment presented by way of views 421A-H. Examples of computing system 400 include mobile computing devices, desktop computers, cell phones, tablet computers, laptop computers, notebook computers, media devices, and gaming devices, as well as any other type of mobile computing devices, combination, or variation thereof.

Computing system 400 includes processing system 401, storage system 403, software 405, communication interface 407, and user interface 409. Processing system 401 is operatively coupled with storage system 403, communication interface 407, and user interface 409. Processing system 401 loads and executes software 405 from storage system 403. When executed by computing system 400 in general, and processing system 401 in particular, software 405 directs computing system 400 to operate as described herein with respect to views 421A-H. Computing system 300 may optionally include additional devices, features, or functionality not discussed here for purposes of brevity.

Referring still to FIG. 4, processing system 401 may comprise a microprocessor and other circuitry that retrieves and executes software 405 from storage system 403. Processing system 401 may be implemented within a single processing device but may also be distributed across multiple processing devices or sub-systems that cooperate in executing program instructions. Examples of processing system 401 include general purpose central processing units, application specific processors, and logic devices, as well as any other type of processing device, combinations, or variations thereof.

Storage system 403 may comprise any computer readable storage media readable by processing system 401 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal. In addition to storage media, in some implementations storage system 403 may also include communication media over which software 405 may be communicated internally or externally. Storage system 403 may be implemented as a single storage device but may also be implemented across multiple storage devices or sub-systems co-located or distributed relative to each other. Storage system 403 may comprise additional elements, such as a controller, capable of communicating with processing system 401.

Software 405 may be implemented in program instructions and among other functions may, when executed by computing system 400 in general or processing system 401 in particular, direct computing system 400 or processing system 401 to operate as described herein for views 421A-H. Software 405 may include additional processes, programs, or components, such as operating system software or other application software. Software 405 may also comprise firmware or some other form of machine-readable processing instructions executable by processing system 401.

Communication interface 407 may include communication connections and devices that allow for communication between computing system 400 and other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface 409 may include a mouse, a voice input device, a touch input device for receiving a touch gesture from a user, a motion input device for detecting non-touch gestures and other motions by a user, and other comparable input devices and associated processing elements capable of receiving user input, such as inclusion gestures and option gestures, from a user. Output devices such as a display, speakers, haptic devices, and other types of output devices may also be included in user interface 409. In some cases, the input and output devices may be combined in a single device, such as a display or surface capable of displaying images, such as views of contact environment 101, and receiving touch gestures. The aforementioned user input and output devices are well known in the art and need not be discussed at length here. User interface 409 may also include associated user interface software executable by processing system 401 in support of the various user input and output devices discussed above. Separately or in conjunction with each other and other hardware and software elements, the user interface software and devices may provide a graphical user interface, a natural user interface, or any other kind of user interface.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable storage media having program instructions stored thereon for facilitating a contact environment that, when executed by a computing system, direct the computing system to at least:
responsive to a plurality of inclusion gestures, each of the plurality of inclusion gestures indicative of an intention to include a different one of a plurality of contacts in an option group, present a view of the contact environment comprising the plurality of contacts, a plurality of included contacts in the option group, and a plurality of command options applicable to the plurality of included contacts in the option group; and
responsive to an option gesture corresponding to a specific option represented in the plurality of command options, initiate a command operation with the plurality of included contacts in accordance with the specific option.

2. The one or more computer readable media of claim 1 wherein the contact environment comprises a canvas, an application bar arranged adjacent to the canvas, and a contact basket arranged within the application bar and having the plurality of included contacts represented therein.

3. The one or more computer readable storage media of claim 1 wherein the contact environment comprises a canvas and wherein the program instructions further direct the computing system to present the view of the contact environment with the plurality of contacts arranged separately from the plurality of included contacts on the canvas.

4. The one or more computer readable storage media of claim 3 wherein the plurality of contacts comprises a plurality of individual contacts and wherein at least one of the plurality of inclusion gestures comprises a slide gesture directed from at least one of the plurality of individual contacts over the canvas towards the plurality of included contacts in the option group.

5. The one or more computer readable storage media of claim 1 wherein the command options comprise communication options and wherein the command operation comprises a communication session.

6. The one or more computer readable media of claim 1 wherein the program instructions further direct the computing system to, responsive to an exclusion gesture indicative of an intention to exclude a contact from the option group, present a modified view of the contact environment comprising the plurality of included contacts, less the contact, in the option group.

7. The one or more computer readable media of claim 6 wherein the contact environment further comprises a group graphic having the plurality of included contacts arranged therein and wherein the program instructions further direct the computing system to expand the group graphic as at least one of the plurality of inclusion gestures occurs and contract the group graphic when the exclusion gesture occurs.

8. The one or more computer readable media of claim 1 wherein the program instructions further direct the computing system to, responsive to an object inclusion gesture indicative of an intention to include an object in the plurality of included contacts, include the object in the command operation.

9. A computing apparatus comprising:
a computer readable storage media; and
program instructions stored on the computer readable storage media that, when executed by a processing system, direct the processing system to at least:
initiate presentation of a view of a contact environment comprising a canvas and a plurality of contacts arranged on the canvas;
responsive to a plurality of inclusion gestures, each gestures indicative of an intention to include a different one of the plurality of contacts in an option group, identify which of the plurality of contacts to include in the option group; and
present a modified view of the contact environment comprising a plurality of included contacts identified in response to the plurality of inclusion gestures.

10. The computing apparatus of claim 9 wherein the contact environment further comprises an application bar arranged adjacent to the canvas and a contact basket arranged within the application bar having the plurality of included contacts represented therein.

11. The computing apparatus of claim 9 wherein the contact environment further comprises a plurality of command options applicable to the option group and wherein the program instructions further direct the processing system to, responsive to an option gesture corresponding to a specific option represented in the plurality of command options, initiate a command operation with the plurality of included contacts in accordance with the specific communication option.

12. The computing apparatus of claim 9 wherein the plurality of contacts comprises a plurality of individual contacts and wherein at least one of the plurality of inclusion gestures comprises a slide gesture directed from at least one of the plurality of individual contacts over the canvas towards the plurality of included contacts.

13. The computing apparatus of claim 9 wherein the command options comprise communication options and wherein the command operation comprises a communication session.

14. The computing apparatus of claim 9 wherein the computing apparatus further comprises the processing system configured to execute the program instructions.

15. A method for facilitating a contact environment, the method comprising:
receiving a plurality of inclusion gestures, each indicative of an intention to include a different one of a plurality of contacts in an option group;
responsive to the plurality of inclusion gestures, presenting a view of a contact environment comprising the plurality of contacts, a plurality of included contacts in the option group, and a plurality of command options applicable to the plurality of included contacts in the option group; and
responsive to an option gesture corresponding to a specific option represented in the view of the plurality of command options, initiating a command operation with the plurality of included contacts in accordance with the specific option.

16. The method of claim 15 further comprising, responsive to an object inclusion gesture indicative of an intention to include an object in the plurality of included contacts, including the object in the command operation.

17. The method of claim 15 wherein the contact environment further comprises a canvas, an application bar arranged adjacent to the canvas, and a contact basket arranged within the application bar and having the plurality of included contacts represented therein.

18. The method of claim 15 wherein the contact environment comprises a canvas and wherein the method further comprises presenting the view of the contact environment with the plurality of contacts arranged on the canvas.

19. The method of claim 18 wherein the plurality of contacts comprises a plurality of individual contacts and wherein at least one of the plurality of inclusion gestures comprises a slide gesture directed from at least one of the plurality of individual contacts over the canvas towards the plurality of included contacts in the option group.

20. The method of claim 15 further comprising:
responsive to an exclusion gesture indicative of an intention to exclude a contact from the option group, eliminating the contact from the plurality of included contacts;
visually expanding the option group as at least one of the plurality of inclusion gestures occurs; and
visually contracting the option group when the exclusion gesture occurs.
